(19) United States
(12) Patent Application Publication
(10) Pub. No.: US 2026/0057468 A1
(43) Pub. Date: Feb. 26, 2026

(54) System

(71) Applicant: Softbank Group Corp., Tokyo (JP)

(72) Inventor: Yuzo Shimono, Tokyo (JP)

(21) Appl. No.: 19/301,454

(22) Filed: Aug. 15, 2025

(30) Foreign Application Priority Data
Aug. 20, 2024 (JP) 2024-138755

(51) Int. Cl. G06Q 50/26; G05D 1/689; G05D 1/69; G05D 105/55; G05D 105/80; G05D 109/20; G06T 17/05; G06V 20/17

(52) U.S. Cl. CPC G06Q 50/265; G06T 17/05; G06V 20/17; G05D 1/689; G05D 1/69; G05D 2105/55; G05D 2105/80; G05D 2109/20

(57) ABSTRACT

A system includes a processor that is configured to detect occurrence of a disaster, activate a plurality of unmanned aerial vehicles and collect image and video data of a disaster-affected area, analyze the collected image and video data and generate a damage assessment as a three-dimensional map, visualize the generated three-dimensional map and distribute countermeasure instructions, receive information from residents of shelters and rescue workers, and extract important information by natural language analysis, and determine rescue activity instructions and support goods transport routes based on the extracted information.

### CROSS-REFERENCE TO RELATED APPLICATION

This application is based on and claims priority under 35 USC 119 from Japanese Patent Application No. 2024-138755 filed on Aug. 20, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In the event of a large-scale disaster such as an earthquake, flood, or other natural catastrophe, it is extremely difficult to quickly and accurately grasp the extent of the damage, efficiently collect situational information from the affected area, promptly determine the necessary countermeasures, and effectively deliver rescue instructions and aid supplies based on real on-site needs. Existing systems often face problems such as delays in damage assessment, lack of real-time communication, and inefficient allocation of rescue resources, which can significantly hinder timely and effective disaster response.

### SUMMARY

To solve these problems, the present invention provides a system comprising a processor configured to: detect the occurrence of a disaster; activate a plurality of unmanned aerial vehicles to collect image and video data of the affected area; analyze the collected data and generate a three-dimensional damage assessment map; visualize the generated map and distribute countermeasure instructions; receive information from residents and rescue workers via natural language input; extract essential information using natural language analysis; and determine rescue activity instructions and optimize transport routes for support goods based on the extracted information. This comprehensive approach enables prompt, accurate, and efficient disaster response.

“Disaster” means that an event such as an earthquake, flood, or other natural or man-made catastrophe has occurred, causing damage to people, infrastructure, or property.

“Unmanned aerial vehicle” means that an aircraft is operated without a human pilot onboard and is controlled remotely or autonomously, typically for data collection or surveillance purposes.
“Processor” means that a hardware and/or software computational unit is provided for executing instructions, processing data, and controlling the operations of the system.
“Image and video data” means that digital information captured by cameras or sensors, including still images and continuous video footage, is used for analysis of the disaster-affected area.
“Three-dimensional map” means that a digital representation is created which models the physical structure of a region, including height, depth, and spatial features, to visualize the extent of damage.
“Visualization” means that data or analysis results are graphically represented or displayed in a format that allows users to intuitively grasp information.
“Countermeasure instructions” means that directives or guidance are automatically generated and communicated for the purpose of disaster mitigation, rescue, or relief activities.
“Natural language analysis” means that computational techniques are applied to interpret, extract, and process important information from messages or reports written in ordinary human language.
“Residents of shelters” means that people temporarily residing in designated safe locations due to evacuation from a disaster-affected area.
“Rescue workers” means that individuals or teams are involved in on-site emergency response, rescue, and relief operations.
“Support goods transport routes” means that the travel paths or logistical plans are determined for delivering necessary aid supplies to affected locations efficiently.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

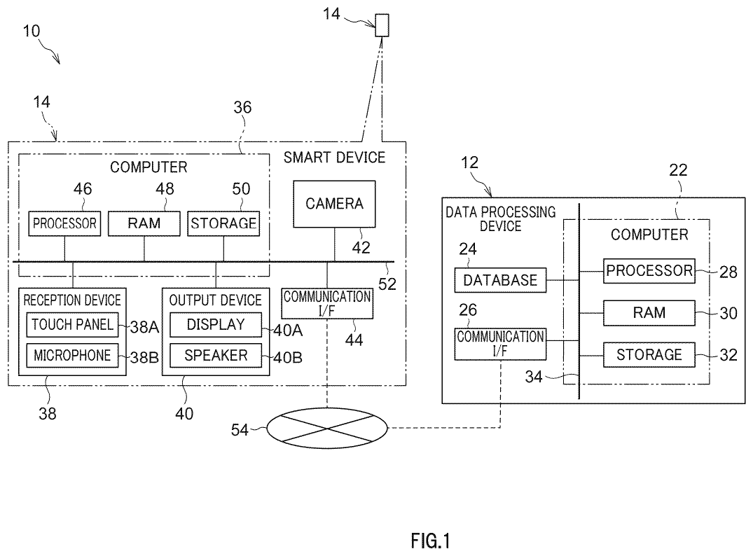

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

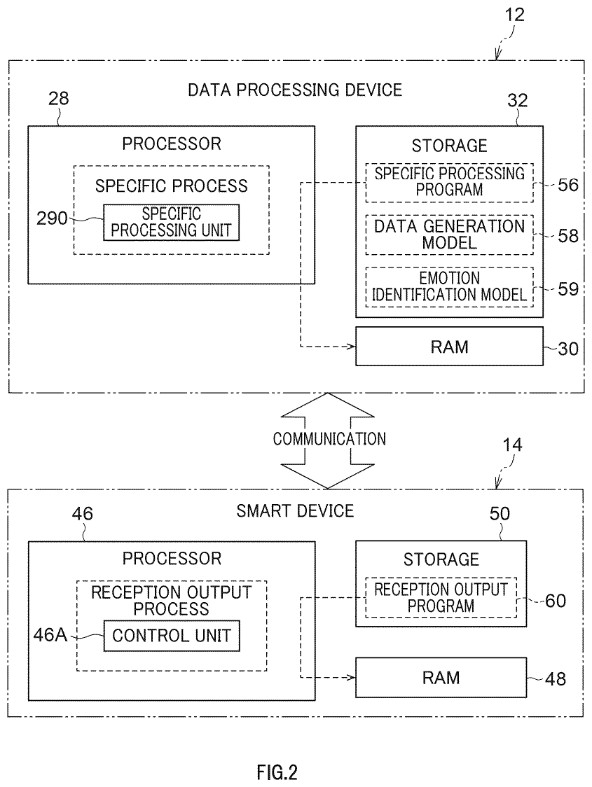

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the event of natural disasters, such as earthquakes, floods, or severe weather events, there is a significant challenge in rapidly and accurately assessing the extent of damage and coordinating effective relief activities. Conventional methods rely on manually collected reports and on-site inspections, which can be time-consuming, lack real-time accuracy, and often hinder timely decision-making for resource allocation and rescue operations. Furthermore, existing systems often struggle to efficiently assimilate large volumes of heterogeneous data, such as aerial imagery, user-submitted reports, and sensor information, thereby limiting the ability to generate comprehensive situational awareness and optimized relief plans.

The specific processing by the specific processing unit 290 of the data processing device 12 in Example 1 is realized by the following means.

The present invention provides a server comprising a processor configured to detect occurrences of disasters using environmental information change detection devices, control a plurality of aerial vehicles for autonomous collection of video and image data, store and analyze such data to generate spatial information, visualize the results, extract key information from on-site reports via natural language processing, automatically generate relief guidance and optimized logistics routes using a generative processing model, and distribute this information to relevant parties via push notification mechanisms. This enables rapid, real-time, and automated assessment of disaster areas, efficient extraction and analysis of multi-source information, and timely distribution of optimized relief instructions to support effective disaster response activities.

The term “environmental information change detection device” refers to a device or system that monitors environmental conditions, such as seismic activity, weather patterns, or water levels, and determines the occurrence of a disaster based on predefined changes or anomalies in the collected data.

The term “aerial vehicle” refers to an unmanned flying apparatus, including but not limited to drones or other autonomous aircraft, capable of carrying imaging equipment and following specified flight routes.
The term “video information and image information” refers to digital multimedia data, such as video recordings, photographs, or other visual capture formats, collected from the observation region for the purposes of disaster assessment.
The term “communication network” refers to a digital infrastructure, such as a wireless or wired data transmission system, enabling the transfer of collected data between aerial vehicles and the server or storage device.
The term “recording medium” refers to a data storage system or memory unit-such as cloud storage, server-based databases, or local memory-used to securely store the collected multimedia data.
The term “spatial information data” refers to digital data sets modeling the three-dimensional or geographic aspects of the observed region, generated by analyzing the collected video or image data.
The term “visualization display device” refers to electronic hardware, such as monitors, screens, or computing terminals, capable of rendering and presenting spatial information data for human viewing.
The term “information notification means” refers to any system or method, such as email, messaging platforms, or push notifications, used to communicate guidance, alerts, or instructions to relevant users or stakeholders.
The term “information input terminal” refers to electronic devices, such as smartphones, tablet computers, or computers, that allow users on-site to submit structured or unstructured information regarding the disaster situation.
The term “structured information or unstructured information” refers respectively to data submitted in predefined formats (such as forms or checklists) or in free-text, image, or voice-based submissions.
The term “natural language processing technology” refers to artificial intelligence software, algorithms, or models designed to analyze and extract key information from human language data submitted in the form of text or speech.
The term “support activity plan” refers to a coordinated strategy generated to guide relief and rescue operations, taking into account the current needs, resources, and priorities identified in the collected information.
The term “optimal transportation route” refers to a calculated delivery or travel path for relief resources that minimizes travel time, risk, or resource consumption based on current geographic and logistical constraints.
The term “generative processing model” refers to an artificial intelligence or machine learning system capable of automatically producing analysis results, recommendations, or guidance based on multi-source data inputs.
The term “push notification mechanism” refers to a technology that delivers instant messages or updates from a central system to the user devices of participants or responders in the disaster area.

The system comprises a server equipped with a processor, memory, and network interfaces, as well as multiple terminals such as unmanned aerial vehicles (referred to as aerial vehicles or drones), and user-operated devices such as smartphones or computers. The system also employs various environmental information change detection devices, including but not limited to seismic sensors, meteorological sensors, or water level sensors, which are connected to the server via a communication network.

The server utilizes both hardware and software to implement the functions defined in the claims. For practical deployment, the server can be a generic computing server or a cloud instance. It is recommended to use a cloud platform service to enable reliable storage and scalability. The server executes programs that manage disaster detection, data acquisition, storage, analysis, visualization, and transmission of instructions.
First, the server is programmed to detect occurrences of disasters by analyzing real-time data sent from a variety of environmental information change detection devices. The server collects and evaluates sensor data using standard data aggregation middleware and statistical analysis software. Once a disaster is detected, the server sends control commands, generated by drone control software such as a Drone Control API, to multiple aerial vehicles. These aerial vehicles are equipped with image acquisition devices such as high-resolution cameras (for example, comparable to modules from well-known manufacturers like those typically used in commercial drone systems) and communication modules supporting high-speed, wireless data transmission such as cellular networks (for instance, 5G modules).
The terminals, functioning as aerial vehicles, autonomously navigate according to preset flight routes stored in their onboard computers. These routes are determined by the server and uploaded to each aerial vehicle prior to takeoff. The aerial vehicles capture video information and image information of the observation region, and then transfer the collected media files directly to the server using secure wireless communication. The server transfers and stores the received video and image files onto a recording medium, such as cloud storage. For this process, cloud infrastructure like object storage services and robust user authentication control are recommended. The recording medium ensures that the data is sorted and secured by metadata such as timestamps, GPS coordinates, and device identifiers.
After storage, the server initiates processing using artificial intelligence frameworks such as a generative AI model implemented with a deep learning library (for example, a framework comparable to TensorFlow). The server preprocesses the video and image data and inputs it into the generative AI model for analysis. The generative AI model automatically generates spatial information data, such as three-dimensional maps or damage assessments, by comparing new data with baseline data acquired prior to the disaster. This spatial information data is then delivered to a visualization display device using specialized visualization software (such as a general-purpose data visualization platform). The server also utilizes information notification means, which might include email messaging APIs or push notification platforms, to communicate response guidance to related parties.
The user, operating an information input terminal such as a mobile application or web portal, inputs structured information (e.g., checklists) or unstructured information (e.g., free-text messages, photos, voice recordings), which are transmitted to the server through secure communication. The server receives this information and applies natural language processing technology, utilizing an artificial intelligence model for information extraction. The extracted key issues, such as urgent needs or on-site hazards, are analyzed together with resource information stored in the system.
The server creates a support activity plan and calculates optimal transportation routes for relief goods using algorithms integrated with geographic information systems and mapping APIs. A generative processing model further enhances decision-making by automatically synthesizing response instructions and logistics plans. The server finally transmits these instructions and transportation routes as push notifications to relevant user terminals-such as those carried by emergency responders.
A specific example can be given as follows: In the event of an earthquake, the server detects abnormal readings from seismic sensors, activates multiple drones, and collects aerial images over the disaster area. The images are processed to generate a 3D map identifying collapsed structures. Residents use a mobile app to send requests indicating needs for food or water, and the server processes this data with natural language understanding to update supply priorities. The server then calculates fastest delivery routes and notifies drivers of required actions via their mobile devices.
An example of a prompt sentence used with the generative AI model is:
“Please analyze the video and image data from the disaster area and generate a prioritized list of relief activities along with a color-coded 3D damage map.”
This system enables highly automated, rapid, and accurate situational awareness and optimized relief coordination in times of disaster, and can be implemented using widely available computing, communication, and machine learning technologies.

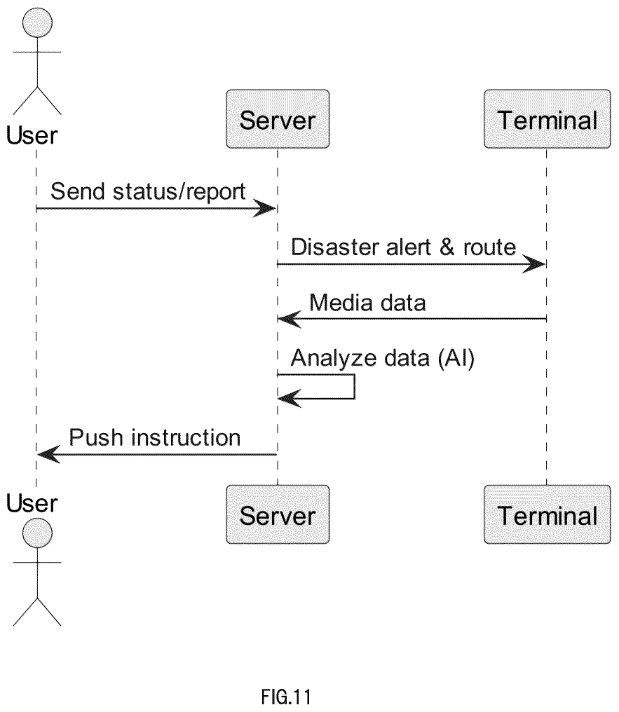

The following describes the processing flow using FIG. 11.

### Step 1:

Server collects real-time data from environmental information change detection devices, including seismic sensors and meteorological sensors. The input is sensor data streams, and the output is an evaluation of whether disaster-related thresholds are exceeded. Server processes raw sensor readings by performing statistical analysis and anomaly detection on incoming data.

### Step 2:

Server determines that a disaster has occurred if threshold values are exceeded. The input is processed evaluation results from Step 1; the output is a disaster occurrence signal. Server generates a command to initiate emergency protocols.

### Step 3:

Server sends commands to multiple terminals (aerial vehicles) to activate and upload preset autonomous flight routes. The input is the disaster occurrence signal, and the output is delivery of commands and flight paths to the terminals. Server retrieves stored waypoints and prepares encrypted command packets.

### Step 4:

Terminal (aerial vehicle) receives the command and autonomously takes off, following the uploaded flight route. The input is the received flight plan; the output is flight status and ongoing media acquisition. Terminal initializes navigation modules and image acquisition devices such as high-resolution cameras.

### Step 5:

Terminal captures video information and image information at predetermined intervals along the flight path. The input is current GPS position and timing signals, and the output is raw video files and image files stored locally. Terminal stamps each file with metadata such as location, altitude, and timestamp.

### Step 6:

Terminal transmits the collected video and image data in real time to the server via a wireless communication network. The input is raw or compressed media files; the output is transfer confirmation and data receipt notifications. Terminal performs file compression, encrypts the data, and monitors network integrity to ensure complete transfer.

### Step 7:

Server receives, verifies, and stores the transmitted video and image data onto a secure recording medium in the cloud. The input is incoming media data streams; the output is verified and saved media files with associated metadata. Server checks data integrity using hash verification and sorts files in cloud storage by timestamp and terminal identifier.

### Step 8:

Server preprocesses the stored media (resizing, normalization) and inputs it into a generative AI model. The input is the batch of verified media files; the output is spatial information data, including 3D maps and damage assessment results. Server runs inference using a trained deep learning model and compares new data to baseline pre-disaster data.

### Step 9:

Server visualizes the generated spatial information data on a visualization display device and prepares instruction information for distribution. The input is the output from the AI model; the output is rendered 3D visualizations and generated relief guidance. Server formats the guidance for various display formats and notification platforms.

### Step 10:

User (on-site personnel or resident) inputs structured or unstructured information, such as requests or status reports, via an information input terminal. The input is user-generated data (text, images, or voice); the output is successful data transfer to the server. User selects location within the app and attaches supplementary information as needed.

### Step 11:

Server receives user-submitted information and applies a natural language processing AI model to extract key issues and urgent needs. The input is user communication; the output is a set of prioritized needs and extracted information. Server tokenizes user reports and applies classification and entity extraction routines.

### Step 12:

Server formulates a support activity plan and calculates optimal transportation routes for relief resources. The input is extracted needs and current resource data; the output is logistics plans and route assignments. Server uses mapping APIs and constraint-based optimization algorithms to generate route recommendations.

### Step 13:

Server uses a generative AI model to synthesize comprehensive response instructions and logistics orders for responders, based on analysis results and current priorities. The input is the combined spatial data, user reports, and logistics calculations; the output is structured guidance messages. Server assembles and personalizes the guidance for different field units.

### Step 14:

Server distributes the guidance and route information to registered user terminals through a push notification mechanism. The input is guidance messages; the output is real-time alerts and delivery confirmations on responder devices. Server sends notifications via a messaging API and receives acknowledgment of receipt.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In the event of a disaster, promptly and accurately grasping the scale and details of damages, effectively collecting situational data from disaster sites, and dynamically coordinating relief activities and the delivery of support goods are crucial. However, conventional systems have significant limitations in interlinking damage assessment, route planning, and resource prioritization, especially in environments where the conditions change rapidly and incoming information includes both objective requests and contextual, emotional signals from victims and field responders. Moreover, the automation and optimization of supply logistics and real-time activity instructions, based on comprehensive on-the-ground data and machine learning analysis, have not yet been adequately realized.

The specific processing by the specific processing unit 290 of the data processing device 12 in Application Example 1 is realized by the following means.

The present invention provides a server comprising a processor configured to detect disaster events through aggregation of sensor data, remotely control unmanned vehicles to collect image and video data, analyze said data using a generative artificial intelligence model, create and visualize a three-dimensional map of the disaster area, receive situational and emotional data from local users through language processing, and dynamically generate and distribute optimized relief activity instructions and delivery routes based on comprehensive, real-time information. This enables rapid, accurate, and data-driven disaster management and logistics by automating situation analysis, integrating emotional information from the field, and adaptively optimizing resource allocation and route instructions for stakeholders.

The term “processor” refers to an information processing unit capable of executing instructions, performing data analysis, and controlling various hardware or software components within the system.

The term “observation device” refers to a generic apparatus for monitoring environmental conditions, such as weather stations, seismic sensors, or other data acquisition instruments deployed for detecting disaster-related phenomena.
The term “environmental measuring device” refers to a sensor or instrument for acquiring environmental parameters, including but not limited to, water levels, atmospheric conditions, seismic activity, or other measurable variables associated with disaster events.
The term “sensing data” refers to electronic data that is collected by observation devices and environmental measuring devices, comprising physical, chemical, or other environmental measurements relevant to disaster detection.
The term “unmanned mobile unit” refers to a remotely operated or autonomous vehicle, such as an unmanned aerial vehicle or ground robot, capable of moving within a designated area to perform information collection tasks.
The term “imaging device” refers to an optical or electronic apparatus mounted on an unmanned mobile unit for capturing still images or video data of an environment.
The term “management device” refers to a general-purpose or specialized computing apparatus that receives, stores, and processes data from unmanned mobile units and coordinates further analysis and decision-making processes.
The term “communication network” refers to any wired or wireless data transmission system used to facilitate the exchange of information between system components, including local area networks, cellular networks, or the internet.
The term “data storage device” refers to a physical or virtual device capable of electronically storing data, such as a disk array, solid-state drive, or cloud storage service.
The term “reference data” refers to previously recorded spatial or environmental data obtained prior to the occurrence of a disaster event, serving as a baseline for post-disaster comparison and analysis.
The term “machine learning process” refers to a data analysis method utilizing algorithms that learn patterns from training data and automatically extract information, classify data, or make predictions based on new input.
The term “generative artificial intelligence model” refers to an artificial intelligence system that can analyze, interpret, and synthesize new information or data representations, such as through deep learning, natural language generation, or computer vision techniques.
The term “three-dimensional display data” refers to synthesized data representing the spatial characteristics of affected areas, structured to enable graphical visualization in three dimensions for situational awareness and decision support.
The term “spatial information” refers to geographic, positional, or geometric data necessary for reconstructing, visualizing, or analyzing the features and conditions of an area.
The term “stakeholder” refers to any individual, group, or organization that plays a role in disaster relief, management, or decision-making, such as public authorities, logistics coordinators, or field responders.
The term “countermeasure instruction” refers to an automatic or semi-automatic directive generated by the system to guide disaster response actions, resource allocations, or operational procedures.
The term “information input device” refers to an interface or apparatus through which users, whether on-site or remote, can submit data, status updates, or requests to the system, such as via a mobile terminal or web interface.
The term “natural language processing technology” refers to a computational technique for analyzing textual or spoken language data, enabling the extraction of essential facts, intent, or sentiment from unstructured human communications.
The term “emotional information” refers to data derived from user communications indicating psychological states such as urgency, distress, anxiety, or other affective conditions, as interpreted by emotion analysis algorithms.
The term “transportation means” refers to any vehicle or system capable of delivering support items or personnel to designated locations, which may include land vehicles, aircraft, or unmanned devices.
The term “activity instruction” refers to an operational directive or plan generated by the system to specify and coordinate actions required of stakeholders during disaster response operations.
The term “terminal” refers to a user-facing device, such as a computer workstation, tablet, or mobile device, that displays information or instructions generated by the system and enables interaction with users.

### Embodiment for Implementing the Invention

According to the present invention, the disaster response system comprises a processor that serves as the core of the server and executes all necessary operations for automated disaster management, information gathering, and relief coordination. The following is a detailed description of one embodiment for implementing this invention, including hardware and software configuration, functional operation, and a specific usage example.
The server may be implemented using a general-purpose or dedicated information processing apparatus, such as a computer workstation or cloud computing platform. Preferred hardware includes multicore processors, ample RAM, and a stable data storage subsystem, such as solid state drives or cloud storage (for example, a commercial cloud storage service). A robust communication network, such as wired Ethernet, 4G/5G wireless, or similar, connects the server to peripheral devices and other system components.
Sensor modules—such as weather observation devices, seismic sensors, and water-level measurement devices—are deployed in the environment to deliver environmental and event data (sensing data) to the server. This data is aggregated on the server to monitor for potential disaster events. When the server detects that disaster event thresholds are exceeded, it immediately issues remote activation commands to a group of unmanned mobile units. These unmanned mobile units, which may be in the form of aerial drones or ground robots, are each equipped with imaging devices such as high-resolution cameras.
Upon receiving activation instructions from the server, the terminal (the unmanned mobile unit) autonomously follows a predefined or dynamically assigned route within the affected area, capturing image and video data. Onboard software (for example, an autopilot platform and camera control firmware) coordinates autonomous navigation and continuous data capture. As imaging data is collected, the terminal transmits it to the server via a communication network, using encrypted and compressed data transfer protocols to maximize reliability and minimize transmission losses.
The server receives the image and video data from each terminal and stores all files in a structured format on a cloud storage device such as a commercial object storage service. The server then retrieves both current (“after the disaster”) and reference (“before the disaster”) environmental data, if available, for the target area. This dataset is then submitted to a generative artificial intelligence model, which may be implemented as an external API or an internally deployed machine learning model. Popular platforms for this generative AI function include large-scale models that perform image recognition, 3D reconstruction, data comparison, and natural language processing through deep learning techniques.
For AI processing, the server formulates a prompt sentence in natural language-such as “Analyze these images to identify collapsed buildings, flooded areas, and road blockages. Output results as structured information.”—and submits the prompt with the data to the generative AI model. The model returns a structured analysis of damages and their geographic positioning, which is processed by the server to generate interactive three-dimensional display data using geographic information system (GIS) software (examples include OpenCV, Open3D, and visualization frameworks such as CesiumJS or Mapbox).
The server visualizes the generated 3D map and analysis results using display terminals located at logistics centers, administrative headquarters, and other stakeholder sites. Stakeholders can view the damage status, distribution of damages, and recommended countermeasures via these display devices, which may consist of desktop workstations, tablets, or mobile terminals. Automated countermeasure instructions are also generated and distributed to stakeholders and field operators, ensuring that situational awareness and guidance are provided in real time.
Users, including evacuees and relief workers at disaster sites, interact with the system using information input devices such as smartphone applications or chatbots. Users submit free-text or form-based reports containing information about their present circumstances, resource needs, or emotional states. These inputs are automatically timestamped and geotagged. The server receives these reports and uses a natural language processing engine—such as a state-of-the-art language understanding model, including emotion analysis algorithms—to extract important keywords, classify supply requests, and identify the emotional tone of messages. The server dynamically incorporates all extracted information, including emotional data from user messages, into its relief planning logic. Taking into account current supply requests, logistic inventory, road accessibility as identified by drone imagery, and urgency levels, the server optimizes supply allocation and delivery route instructions using operations research algorithms or logistics optimization software.
These dynamically generated instructions and routes are then transmitted back to the terminals or to stakeholder-controlled vehicles responsible for delivering relief items, as well as to the mobile devices of field responders. Whenever new field updates or emotional data are received, the server automatically re-evaluates priorities, re-analyzes real-time data using the generative AI model, optimizes plans, and distributes updated instructions as needed. For example, when a flood is detected based on sensor data, the server immediately commands unmanned aerial vehicles to survey affected regions. Drones send real-time video and geotagged images to the server, which are uploaded to cloud storage for processing. The server uses a generative AI model to identify submerged dwellings, collapsed routes, and dangerous areas, then displays this situational map on the logistics center terminals. If a user at a shelter sends a message such as “We are trapped, water is rising fast, we need help!” via a smartphone app, the emotional severity is recognized and prioritized in supply dispatch, and the fastest and safest route is dynamically assigned based on the latest map and infrastructure status.
An example of a prompt sentence used for submitting data to the generative AI model is as follows:
“Given these images and field reports, detect and categorize damaged infrastructure, extract supply or rescue requests with urgency ranking based on text content and emotional tone, and propose optimal delivery or rescue routes considering reported access issues and blocked roads.”
In this way, the invention provides a detailed, technically robust, and practically feasible system for automated disaster response, information collection, and logistics coordination, leveraging advanced server processing, unmanned terminal operation, generative AI capabilities, and data-driven optimization techniques.

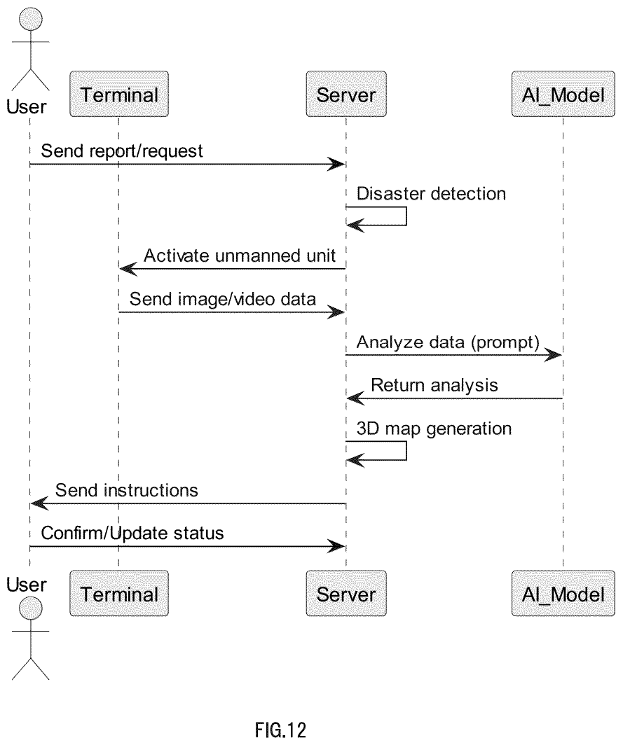

The following describes the processing flow using FIG. 12.

### Step 1:

The server collects real-time sensor data from observation devices and environmental measuring devices deployed in the target area. As input, the server receives continuous streams of data including seismic activity, weather information, and water levels. The server processes this input by aggregating, filtering, and analyzing the sensor data to detect anomalies or events that exceed predefined disaster thresholds. As output, the server generates a disaster detection signal if a disaster event is determined, and logs the event details in the database.

### Step 2:

The server generates activation commands for multiple unmanned mobile units, specifying the target area and mission parameters. The input for this step is the disaster detection signal along with geographic information of the affected area. The server outputs command messages that are transmitted to registered terminals, listing waypoints and data collection instructions. The server also updates a task management system with these deployment details.

### Step 3:

The terminal (unmanned mobile unit) receives the activation command from the server and initiates its power-on and autonomous navigation sequence. The input is the command message with navigation and imaging instructions. The terminal's onboard control system processes the command, powers up the imaging device, and begins autonomous navigation along the designated route. As output, the terminal starts collecting image and video data, and initializes continuous data streams for transmission.

### Step 4:

The terminal (unmanned mobile unit) acquires image and video data using its onboard imaging device as it patrols the designated area. The input is the image capturing command from the terminal's control system, combined with real-time positioning information. The terminal processes the visual and spatial input by encoding, compressing, and encrypting the data. The output is the live or batch data stream, which is transmitted through the communication network to the server.

### Step 5:

The server receives and stores the incoming image and video data from the terminals. The input includes streamed multimedia data as well as associated metadata (e.g., location and timestamp). The server processes the input by verifying data integrity, associating the metadata, and uploading files to the cloud storage device in an organized directory structure. As output, the data is securely stored and indexed for subsequent analysis.

### Step 6:

The server retrieves both pre-disaster reference data and post-disaster image/video data from cloud storage. The input consists of current multimedia data and stored reference datasets. The server processes this data through a comparison step, then prepares and formats the data for submission to the generative AI model. The output is a request packet, which includes the formatted data and a prompt sentence for analysis.

### Step 7:

The server submits the prepared data and prompt sentence to the generative AI model for analysis. The input includes the comparative image datasets and a natural language prompt such as “Analyze these images to identify collapsed buildings, flooded areas, and road blockages.” The generative AI model processes the data using deep learning and computer vision. As output, the model returns structured results, such as detected damage types and their geolocations.

### Step 8:

The server parses the generative AI model's response and generates three-dimensional display data representing the spatial distribution of damage. The input is the structured analysis results from the AI model and geographic information about the area. The server processes this by mapping detected features onto a 3D visualization, which is rendered using GIS software. As output, the server produces an interactive 3D map and visualization files.

### Step 9:

The server distributes the three-dimensional map and situational analysis reports to the terminals at logistics centers and management headquarters. The input is the visualization data. The server transmits the files to the designated terminals and configures dashboard software to display real-time updates. The output is a visual summary available to operators for review and decision-making.

### Step 10:

The user (evacuee or field responder) submits situational reports, resource requests, and comments using an information input device such as a smart device app or chatbot. The input is free-form text, optionally with attached photos and geolocation data. The user sends these messages through a secure channel to the server. As output, the submission is logged and queued for processing.

### Step 11:

The server receives user-submitted messages and prepares them for analysis. The input consists of raw message content, metadata, and media attachments. The server processes this by performing pre-processing, language normalization, and routing the content to both a natural language processing engine and an emotion analysis algorithm. The output is structured message data annotated with extracted information and emotional labels.

### Step 12:

The server integrates information extracted from the user submissions-including resource requests, geographic data, and urgency levels-into its central database. The input is the structured and annotated user data from the previous step. The server processes this by updating the records for shelters, field teams, and supply needs. As output, the system maintains a real-time updated state of resource requirements and situational trends.

### Step 13:

The server optimizes relief operations by aggregating all current analysis results, route status, and prioritized requests. The input includes three-dimensional map data, road and infrastructure status, supply inventory, and user urgency indicators. The server runs a route optimization engine, factoring in variables such as passable roads, resource locations, and request priority. The output is an optimized instruction set-detailed delivery itineraries and actionable activity instructions for relief teams.

### Step 14:

The server transmits instructions and updated route plans to relevant terminals and mobile devices used by field operators and logistics personnel. The input is the optimized instruction set. The server delivers this information in a secure, real-time manner, and the terminals display the new directives. As output, the operators receive actionable plans for immediate execution.

### Step 15:

The user (field operator) and terminal execute the assigned relief activity based on the received instructions. The input is the activity plan, including maps, lists of supplies, and route guidance. The user follows these steps in the physical environment, updating the system on progress or completion. As output, confirmations and progress reports are sent back to the server for ongoing monitoring and further coordination.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the event of a natural disaster, it is often challenging to collect real-time and accurate damage information required for effective and prompt rescue operations.

Conventional systems suffer from delayed information gathering, imprecise assessment of disaster situations, and lack the ability to prioritize support based on the urgency and emotional context reported by individuals on the ground. Moreover, the routing and allocation of relief resources are often suboptimal, leading to inefficient rescue activities and delayed delivery of necessary supplies to those in need.

The specific processing by the specific processing unit 290 of the data processing device 12 in Example 2 is realized by the following means.

The present invention provides a server comprising a processor configured to detect a disaster from sensor information, activate plural unmanned vehicles to collect affected area images, store and process video and image information using a generative artificial intelligence model based on supplied prompt sentences, reconstruct three-dimensional spatial information representing the disaster, visualize this information and generate countermeasure instructions, receive and analyze natural language communications from users and operators including emotion analysis, extract and prioritize important information, and calculate optimized relief instructions and support transportation routes. This enables real-time, AI-assisted situation assessment, prioritized rescue guidance, and efficient resource distribution tailored to both logistical constraints and the emotional urgency of individuals affected by a disaster.

The term “processor” refers to a computing unit or control circuit configured to execute instructions, perform data processing, and control operations within the system.

The term “disaster” refers to an event or occurrence, such as a natural calamity, that poses a threat to human life, infrastructure, or property, including earthquakes, floods, typhoons, and similar emergencies.
The term “sensor” refers to an electronic component or device that detects physical phenomena, such as seismic activity, weather conditions, or water levels, and converts them into data signals for analysis.
The term “unmanned vehicle” refers to a mobile device or platform, such as a drone or robotics system, operated autonomously or by remote control, without an onboard human occupant.
The term “video information and image information” refers to visual data, including still images and moving pictures, acquired by imaging devices such as cameras or optical sensors.
The term “storage device” refers to a hardware unit or memory medium used to record and retain data, such as images, videos, or other digital files.
The term “generative artificial intelligence model” refers to a computing model, constructed by artificial intelligence or machine learning techniques, which generates new data or interprets input data based on learned patterns, and may incorporate prompt sentences to guide data processing.
The term “prompt sentence” refers to a text instruction or query that guides or conditions the behavior and output of an artificial intelligence model during data processing or inference.
The term “three-dimensional spatial information” refers to digital data representing geometric features, shapes, and relative positions in three-dimensional physical space, including models of terrain, buildings, and other objects.
The term “information processing apparatus” refers to a computing device or system that processes, analyzes, and displays digital information, including servers, workstations, or terminals.
The term “display device” refers to a hardware device or user interface component, such as a monitor or screen, used for visualizing digital content to an operator or end user.
The term “user terminal” refers to an endpoint device, such as a smartphone, tablet, computer, or other communication interface, operated by an end user or support operator.
The term “communication information” refers to data, such as text messages, status reports, or requests, transmitted between users, operators, and the system.
The term “emotion analysis” refers to a type of data processing that detects, interprets, and classifies the emotional state or urgency expressed in received communications, using natural language processing and artificial intelligence techniques.
The term “natural language processing” refers to automated computational techniques for analyzing, understanding, and extracting information from human language inputs, such as text or speech.
The term “database” refers to a structured collection of data organized for efficient retrieval, update, and management by a data processing system.
The term “optimization algorithm” refers to a computational method or procedure designed to find the most effective or efficient solution to a particular problem, such as calculating rescue operation instructions or optimal supply distribution routes.
The term “rescue operation instructions” refers to actionable directives generated by the system, guiding on-site support operators to carry out specific emergency or relief activities.
The term “support transportation route” refers to a computed path or itinerary along which relief supplies or resources are delivered to designated locations affected by a disaster.

An embodiment of the present invention is described below with reference to the structure, operation, and implementation of the system.

The system comprises a processor, one or more storage devices, a plurality of unmanned vehicles (such as aerial drones), terminal user devices, and a network communication interface. The server, functioning as the central processor, supervises disaster detection, drone deployment, data collection and analysis, visualization, user message handling, priority extraction, route optimization, and distribution of rescue instructions.
For disaster detection, the server uses a combination of sensors such as seismic sensors, weather data APIs, and water-level monitors to receive real-time environmental information. An example of a weather data API is Open WeatherMap. The processor in the server performs threshold comparisons using software such as Python, and when a disaster condition is recognized, it triggers the system response sequence.
The server then uses a drone control API (such as the SDK of general-purpose aerial drones) to relay activation and autonomous route instructions to each drone, specifying the region for survey. Unmanned vehicles, equipped with imaging devices (e.g., high-resolution digital cameras), operate autonomously to collect video information and image information of the affected area. Terminals (the unmanned vehicles) utilize on-board wireless communication modules, such as 4G LTE or Wi-Fi, to transmit collected video and image data to the server in real time.
Upon receiving the visual data, the server stores it in a storage device, such as a cloud storage service (e.g., Amazon S3), with event-specific organization for ease of access. The server then prepares the collected data alongside a prompt sentence and inputs both into a generative artificial intelligence model. The generative AI model (e.g., a custom neural network implemented on platforms such as TensorFlow or PyTorch) analyzes the images to reconstruct three-dimensional spatial information representing the disaster-affected area. The AI model may compare images collected before and after the disaster to highlight changes and damages.
The server visualizes the resulting three-dimensional spatial information using a visualization tool, such as CesiumJS or Three.js, on a display device at the control center, and generates countermeasure instructions (such as recommended response actions or evacuation routes) based on the AI analysis. The server transmits these recommendations and supporting data to relevant user terminals, such as smartphones, tablets, or computers used by rescue staff. The system allows users at shelters or in the field (for example, evacuees or rescue workers) to send situation reports or supply requests using a dedicated mobile application or chatbot interface. The server receives such communication information and processes each message with an emotion analysis module (for example, a sentiment analysis tool using HuggingFace Transformers or a cloud-based natural language API). The processor then performs natural language processing on the messages to extract and prioritize needs, taking into account the emotional urgency detected.
The server records the extracted urgent needs and support requests in a database (for example, a PostgreSQL database). It employs an optimization algorithm (for example, Google OR-Tools) along with the generative AI model to calculate the optimal supply transportation route while considering the current disaster environment, such as obstacles indicated in the reconstructed three-dimensional map. The server generates actionable rescue instructions and transmits them in real time to the mobile user terminals of field operatives via a push notification service (for example, Firebase Cloud Messaging).
For illustration, consider a scenario where a user at a shelter sends the message, “We urgently need clean drinking water for 50 people at the high school gym.” The server receives and analyzes the message, recognizes the urgency through emotion analysis, extracts the supply location and type, and generates a countermeasure instruction to prioritize water delivery to that site, calculating the fastest route while avoiding blocked roads identified in the AI-generated map.
Example prompt sentences for the generative AI model include:
“Analyze the image data received from the recent disaster site and generate a three-dimensional map of the damaged area.”
“Compare pre-disaster and post-disaster images to identify collapsed buildings and blocked roads, and use this information to suggest optimal rescue routes.”
“From the support requests received from shelters, extract urgent or emotionally stressed messages and generate a prioritized plan for supply distribution.”
Through this architecture and processing flow, the system enables real-time, AI-assisted disaster assessment, prioritized rescue guidance, and highly efficient distribution of resources tailored to logistical constraints and on-the-ground urgency.

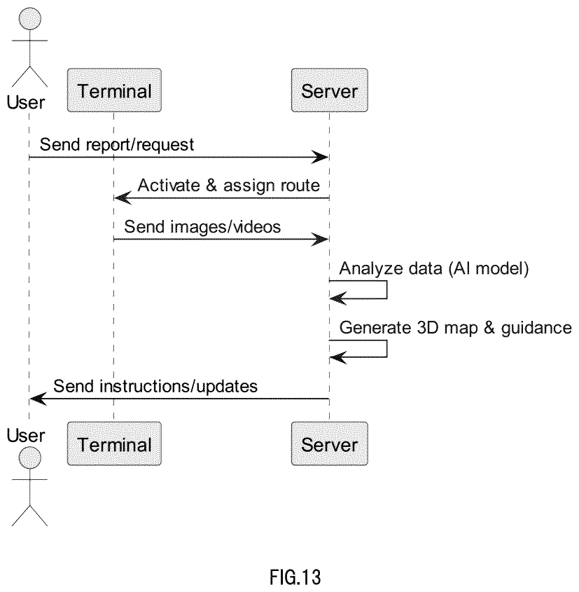

The following describes the processing flow using FIG. 13.

### Step 1:

The server continuously monitors real-time data streams from environmental sensors, weather data APIs, and water-level monitors to detect the occurrence of a disaster. The input for this step consists of sensor data such as seismic readings, rainfall statistics, and river levels. The server compares these values with predefined disaster thresholds using data analysis routines. When a threshold is exceeded, the output is a disaster detection flag that activates the system's response process.

### Step 2:

The server issues activation commands via a drone control API to multiple terminals (unmanned vehicles), instructing them to launch and specifying the target survey area. The input for this step includes the disaster detection flag and GPS coordinates for deployment. The server sends route plans and camera activation signals to each terminal. The output is a set of deployed drones, each following assigned routes.

### Step 3:

Each terminal (drone) receives the commands, powers on its hardware, and begins autonomous navigation according to the uploaded routes. Each drone uses an onboard imaging device to capture high-resolution video and image data of the affected area. The input is the flight path and camera control signals. The terminal collects visual data, encodes it, and transmits it via wireless communication to the server in real time. The output is a stream of visual data files sent to the server.

### Step 4:

The server receives the video and image data from each terminal and organizes this data within a storage device such as a cloud storage folder created specifically for the event. The input consists of visual data streams from drones. The server stores these files with event-timestamped identifiers and updates the internal database. The output is organized and retrievable visual data for further processing.

### Step 5:

The server retrieves visual data from storage and prepares it for analysis. The input is the event-specific visual data and a prompt sentence, such as “Compare pre- and post-disaster images to identify collapsed structures and blocked roads.” The server inputs both into a generative AI model, which processes the data by performing image comparison, object recognition, and geometry reconstruction. The data processing outputs three-dimensional spatial information that details damage areas and environmental changes.

### Step 6:

The server visualizes the generated three-dimensional spatial information using a visualization tool, displaying the output on a command center terminal and overlaying guidance such as critical zones or recommended routes. The input is the three-dimensional spatial data and analysis results. The server processes these inputs and generates countermeasure instructions, which it forwards to the terminals of key personnel. The output is a visually rendered map and a report sent to relevant user terminals.

### Step 7:

Users at shelters or in the disaster area use a mobile application or chatbot to send situation reports and requests for support supplies. The input is natural language messages, sometimes with attached location data or images, generated by the users. The users' actions result in a set of support requests and incident reports uploaded to the server. The output is a batch of messages and requests for processing.

### Step 8:

The server receives these user-generated messages and subjects them to emotion analysis and natural language processing. The input is a set of text messages with possible metadata (e.g., user location, timestamp). The server runs an AI model for sentiment detection and then parses messages for key information such as urgency, supply needs, and location. The output is a structured dataset of extracted, priority-tagged requests.

### Step 9:

The server aggregates the prioritized requests in a database and runs an optimization algorithm in combination with the generative AI model and the latest environmental data. The input consists of structured demand data, current logistics status, and features of the disaster area (e.g., route blockages from the 3D map). The server computes optimal transportation routes and generates actionable instructions for field operators. The output is a complete set of rescue instructions and detailed supply transportation routes.

### Step 10:

The server communicates the instructions and computed routes to the mobile terminals of field personnel via a notification service. The input is the generated rescue guidance and delivery instructions for each operator. The server processes this information and sends it as push notifications or messages. The output is immediate receipt of actionable directives at each field terminal.

### Step 11:

Users (field personnel) acknowledge the instructions and update their task status using their mobile terminals. The input for this step is the set of instructions received and the real-world progress observed (e.g., “arrived”, “delivered”, “route blocked”). Users interact with their terminal interfaces and transmit status updates back to the server. The output is the updated operational status, which the server uses to monitor progress and adapt rescue operations dynamically.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional disaster response systems, there are significant challenges such as delays in information gathering, overlooking crucial information, and the inability to comprehensively and accurately assess the disaster situation in real time. Additionally, such systems cannot adapt operational responses promptly based on continuously updated on-site information and the emotional state of affected individuals. As a result, rescue activities may be inefficient and the allocation of resources may not be properly prioritized, leading to delayed or inadequate support for those in urgent need.

The specific processing by the specific processing unit 290 of the data processing device 12 in Application Example 2 is realized by the following means.

The present invention provides a server comprising a processor configured to collect and analyze real-time observation data from multiple information acquisition devices, activate and control a plurality of aerial vehicles to gather visual data from disaster-affected regions, preprocess and store said data, and utilize a generative information processing device for advanced damage assessment and three-dimensional map generation. The processor is further configured to receive text-based feedback from users, perform emotion extraction and natural language analysis, determine prioritized support actions and optimal delivery routes, and immediately transmit these instructions to field personnel terminals, while also inputting prompt sentences to the generative information processing device as needed. This enables accurate and rapid comprehension of the disaster situation and permits swift, context-sensitive assignment of rescue resources and delivery of support based on both objective damages and user-supplied information, including emotional urgency.

The term “processor” refers to a hardware or software device configured to perform data processing, analysis, control, and execution of programmed functions within the system.

The term “information acquisition device” refers to any hardware apparatus, such as sensors or external data sources, capable of collecting observational data relevant to environmental or disaster conditions.
The term “observation data” refers to data acquired by the information acquisition device, including but not limited to seismic data, meteorological data, images, and other environmental measurements.
The term “aerial vehicle” refers to an unmanned machine capable of flight, such as a drone or unmanned aircraft, used to capture data and images from the air over specified regions.
The term “visual data” refers to images, videos, or other graphical information collected by imaging units onboard aerial vehicles, representing the physical state of the affected area.
The term “storage device” refers to a hardware or virtual medium configured to store digital data, such as a local drive, network-attached storage, or cloud storage environment.
The term “generative information processing device” refers to a computational resource, including but not limited to a generative artificial intelligence model, configured to analyze data, generate text or visual output, and respond to specific prompts.
The term “three-dimensional map information” refers to spatial data produced by the system, visualizing disaster damage and terrain in three-dimensional form, based on visual data analysis.
The term “display control device” refers to an apparatus or software for rendering and presenting map information or guidance visually on the screen of a terminal.
The term “communication device” refers to any apparatus or software for transmitting data between the processor, terminals, and other connected parties within or outside the system.
The term “terminal” refers to an electronic device, such as a user interface device or personnel device, capable of receiving information or instructions from the system.
The term “operation device” refers to hardware or software that enables a user to input or transmit data, such as a keyboard, touchscreen, or mobile application.
The term “emotion extraction processing” refers to computational analysis for identifying and quantifying the emotional content present in input text data.
The term “natural language analysis processing” refers to any technique or algorithm that interprets, classifies, or extracts meaning and key information from natural language text input.
The term “important information” refers to content extracted from input data which is determined to be significant for assessing disaster conditions or supporting response actions.
The term “emotional information” refers to data that represents the identified emotions, urgency, or psychological state present in textual input from users.
The term “support action instruction” refers to operational guidance or directives generated by the processor to guide the actions of personnel in response to prioritized needs during a disaster.
The term “transport route information” refers to data specifying the optimized path or delivery method for support resources or personnel to reach a designated location.
The term “prompt sentence” refers to a structured input delivered to the generative information processing device, formulated to request a specific analysis, output, or response.

### MODE(S) FOR CARRYING OUT THE INVENTION

A preferred embodiment of the present invention may be realized as a disaster response system comprising a server configured as described in the claims and supporting definitions. The server incorporates a processor that executes software modules responsible for data collection, analysis, and coordination with various hardware devices.
The server acquires observation data from information acquisition devices such as environmental sensors, including seismic detectors, weather stations, and flood monitoring devices. These devices may connect to the server via standard communication protocols (for example, using REST APIs or MQTT). The server may utilize general-purpose computing hardware such as a rackmount computer or a cloud-based virtual server running a major operating system, such as Linux or Windows Server.
When the server detects a disaster event by analyzing the incoming observation data, the server issues instructions to multiple aerial vehicles, such as drones equipped with high-resolution cameras. These drones are preloaded with autonomous flight plans designed to cover the affected region efficiently. Drone models may include commercially available unmanned aerial vehicles capable of autonomous navigation, equipped with imaging units and wireless communication modules. For example, the drones may connect using LTE or Wi-Fi for real-time transmission of visual data to the server.
Upon receiving images and video data from the drones, the server stores the collected visual data in a storage device, such as a local network-attached storage device or a cloud storage service provided by a general-purpose provider. The server can preprocess the data, such as by compressing, resizing, or organizing the files, and subsequently forward the data along with a suitable prompt sentence to a generative AI model for advanced analysis. The generative AI model may be provided as software on a remote hardware platform and can include, but is not limited to, large language models and vision-language models available as a cloud service.
The server inputs a prompt sentence to the generative AI model when analysis is required. One example of a prompt sentence is:
“Analyze the following aerial images and determine which buildings are collapsed, identify blocked roads, and generate three-dimensional map data representing the current damage in the affected area.”
According to the response from the generative AI model, the server generates three-dimensional map information that represents the damage state and stores this in the storage device. The server uses a display control device to visualize the three-dimensional map information on the screen of a terminal, such as a command center computer or tablet device used by disaster management personnel. Visualization software may include geographic information system tools or web-based 3D rendering libraries (e.g., CesiumJS or Three.js). The server receives textual information from users, such as disaster victims or field rescuers, via operation devices or communication terminals. These may be implemented as smartphone applications or web-based chat interfaces. The server is configured to analyze the received text using software tools for emotion extraction and natural language processing. For instance, sentiment analysis may be performed using available emotion analysis tools; natural language interpretation may utilize components of the generative AI model or another suitable language processing engine.
The server extracts important information and emotional information from the user messages. Based on such information, as well as the generated three-dimensional map, the server determines support action instructions (for example, which rescue teams to deploy or which resources to deliver) and transport route information (such as optimized delivery routes that avoid blocked roads). The server immediately transmits these instructions and route information to the terminals of field personnel using communication devices, such as push notifications to tablets or smartphones used by rescue teams.
When performing information analysis or determining support action instructions, the server is configured to generate and input prompt sentences to the generative AI model. An example of a prompt sentence for this operation is:
“Given the following user messages and current damage map, extract all urgent support requests and recommend actions and delivery routes for disaster response teams.”
As a concrete example, when the server receives a report such as “We are trapped at Shelter 1, and we have no food or water, some people are injured,” the server uses emotion extraction processing and natural language analysis processing to determine that the request is highly urgent, involves a large number of people, and includes both supply and medical needs. Referring to the three-dimensional map generated from aerial data, the server identifies accessible routes to Shelter 1 and provides immediate instructions to the rescue personnel. In this manner, the present invention enables accurate, rapid, and context-aware comprehension of the disaster situation, as well as prioritization and immediate communication of rescue actions to the field, by utilizing a combination of information acquisition devices, unmanned aerial vehicles, generative artificial intelligence, prompt sentences, and user communication interfaces.

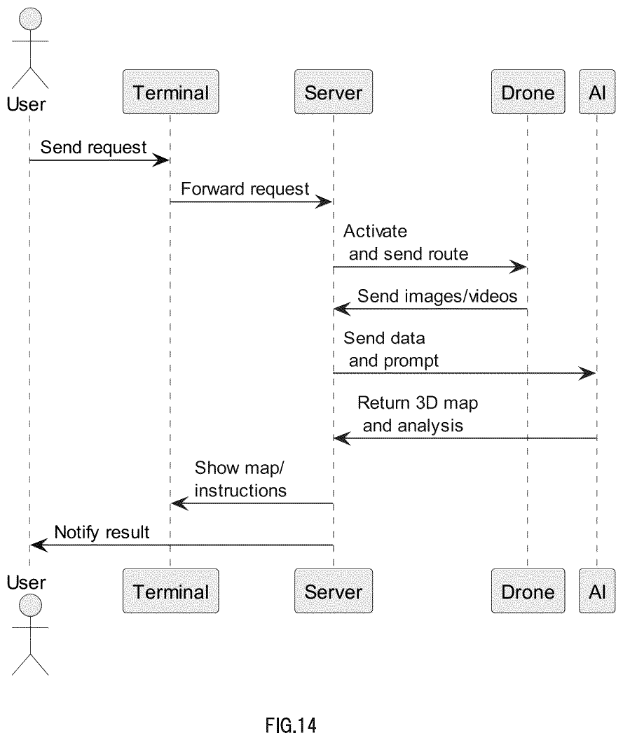

The following describes the processing flow using FIG. 14.

### Step 1:

Server continuously collects observation data from multiple information acquisition devices such as sensors and external data sources. The input is real-time environmental data including seismic readings, weather conditions, and flood levels. The server processes this input data by running anomaly detection algorithms to determine if they meet disaster thresholds. The output is a detection signal that indicates disaster occurrence if the thresholds are exceeded. As a specific action, the server polls data from sensor APIs every minute and checks for abnormal values.

### Step 2:

Server, upon detecting the occurrence of a disaster, initiates commands to a plurality of aerial vehicles to begin surveying the affected area. The input is a disaster detection signal and the geolocation data of the affected area. The server synthesizes flight plans and sends start commands and route details to each drone. The output is the activation and autonomous launch of relevant drones. In concrete steps, the server communicates with drone control APIs to deliver GPS waypoints and altitude instructions.

### Step 3:

Aerial vehicles (drones) follow the prescribed flight routes and collect visual data over the disaster area. The input is the flight path and camera operation instructions. The drones use their onboard imaging units to capture photos and videos according to a set schedule. The output is high-resolution image and video files. Specifically, the drones take a photograph every 5 seconds and stream live video to the server while flying over marked regions.

### Step 4:

Server receives and stores the visual data collected by the drones in a storage device, such as a cloud storage service. The input is the media files transmitted by each drone via wireless communication. The server processes this data by organizing, tagging, and preprocessing the files (e.g., compressing, sorting by timestamp). The output is a structured repository of visual data stored with metadata. Concretely, the server assigns unique IDs to each image and logs their locations in a database.

### Step 5:

Server generates a prompt sentence and submits the collected and preprocessed visual data to a generative AI model for damage assessment. The input is the repository of visual data and an analysis prompt. The server sends the data and prompt to the generative information processing device via API. The output is an analysis result such as extracted damage information and generated three-dimensional map data. As an action, the server may use a prompt sentence like: “Analyze these aerial images and generate a 3D map highlighting damaged buildings and blocked roads.”

### Step 6:

Server uses the generative AI model's response to generate and store three-dimensional map information of the disaster area. The input is the AI-generated 3D map data and damage reports. The server processes this data by converting the results into formats suitable for visualization. The output is a digital 3D map with geolocated damage markers. Specifically, the server translates AI output into a GLTF file and attaches coordinates for collapsed structures.

### Step 7:

Terminal visualizes the three-dimensional map information on the screen, providing real-time situational awareness to response officials. The input is the digital 3D map with annotations sent from the server. The terminal processes this by rendering interactive views using GIS or 3D visualization software. The output is an on-screen display showing the affected area, damage zones, and inaccessible routes. As a specific operation, the terminal highlights buildings in red and blocked roads in yellow on a command center monitor.

### Step 8:

User submits situational reports or resource requests through a mobile application or web interface. The input is the user's text message describing their current status or needs. The terminal transmits this message to the server across the network. The output is the successful delivery of the user message to the central system. For example, the user types “We are at Shelter B with injured people and need water” and sends this through the app.

### Step 9:

Server receives user messages and analyzes them using emotion extraction and natural language analysis processing. The input is the text messages from users. The server applies emotion analytics and parses the messages to extract critical information and assess urgency. The output is a structured list of urgent requests, emotional states, and relevant locations. As a concrete task, the server identifies “need water, urgent, Shelter B” and notes anxiety in the user's message.

### Step 10:

Server determines support action instructions and transport route information based on the extracted information, emotional context, and map data. The input is the structured user request data, emotional analysis, and the latest 3D map. The server calculates priority, selects appropriate response teams, and determines feasible delivery routes avoiding obstacles. The output is a set of operational directives and optimized routes assigned to field personnel. For example, the server uses a route-planning algorithm to assign Team A to deliver water to Shelter B using the fastest accessible road.

### Step 11:

Server transmits support action instructions and transport route information immediately to the terminals of field personnel. The input is the finalized action plan and route details. The server sends these directives using communication devices (such as push notifications or secure messaging). The output is delivery of mission instructions to responders' devices in the field. For instance, the field personnel receive “Deliver medical supplies to Shelter B via Route 4, avoid Route 2 (blocked).”

### Step 12:

Server continuously receives new data from information acquisition devices, aerial vehicles, and users, and updates the analysis and operational plans accordingly. The input is new observation data, visual data, and user messages arriving over time. The server processes these inputs by repeating the data acquisition, analysis, and prioritization steps. The output is an adaptive, updated set of maps and directives that reflect the current disaster situation. For example, if a new obstruction is detected by a drone, the server recalculates and transmits a new route to the assigned team.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

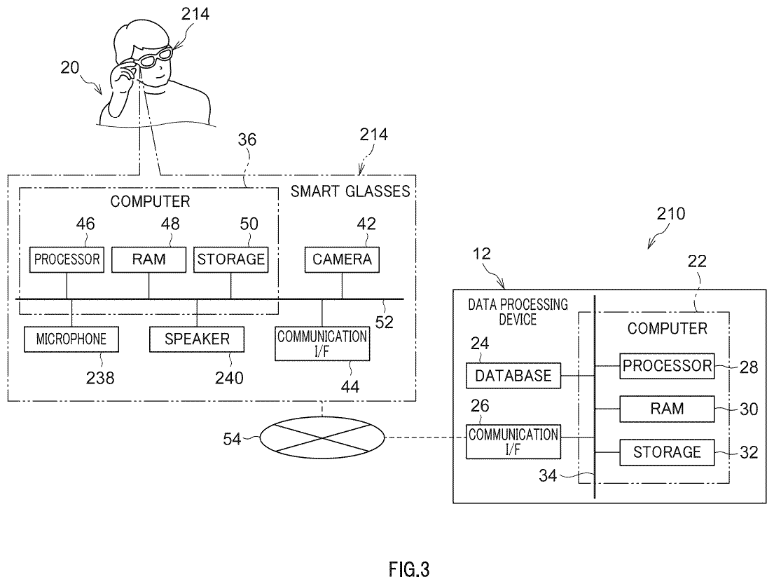

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

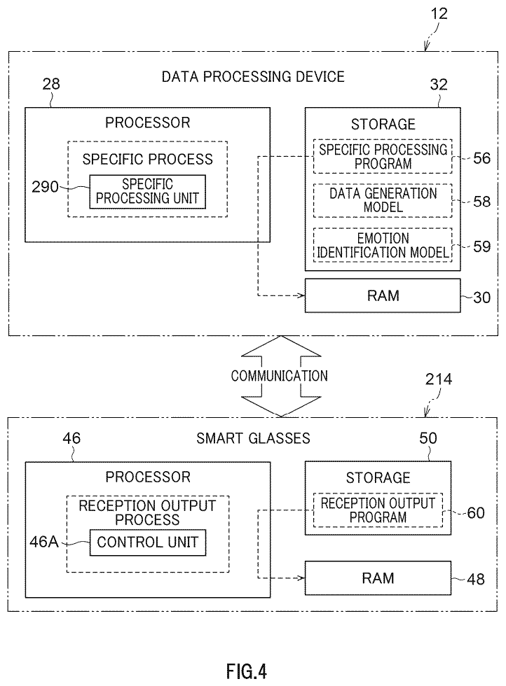

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

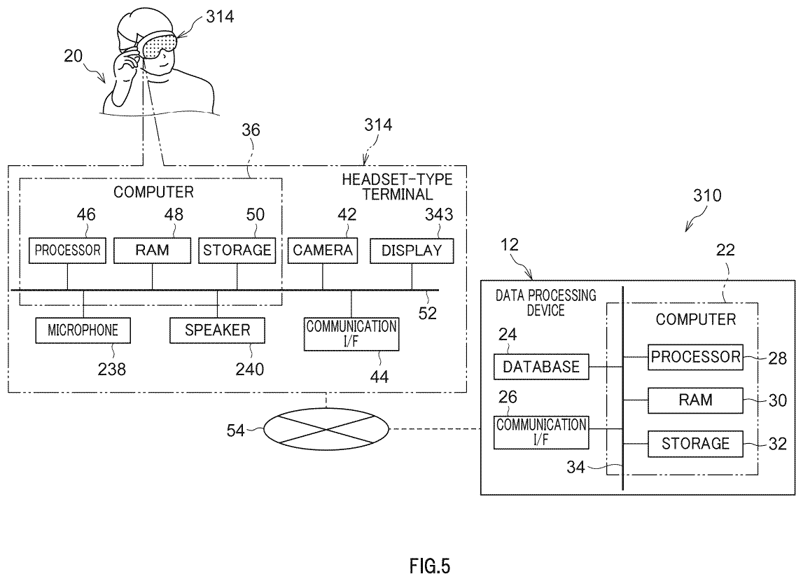

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

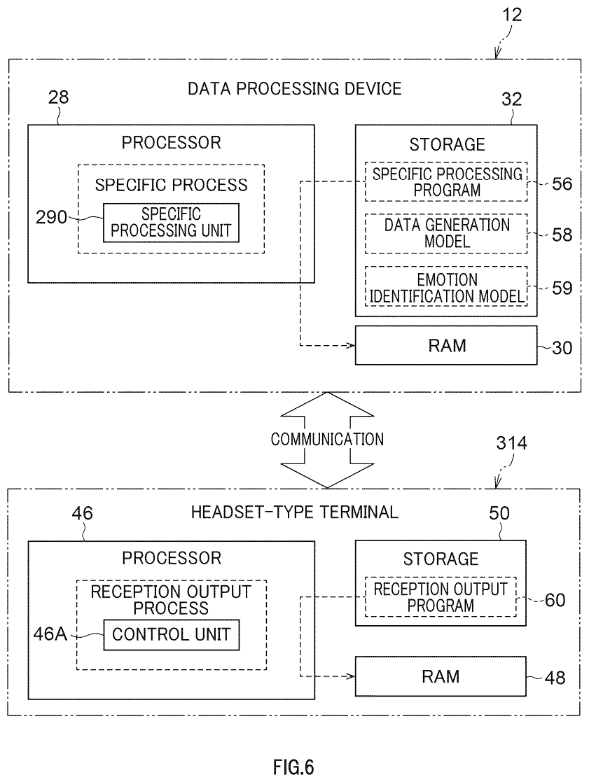

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

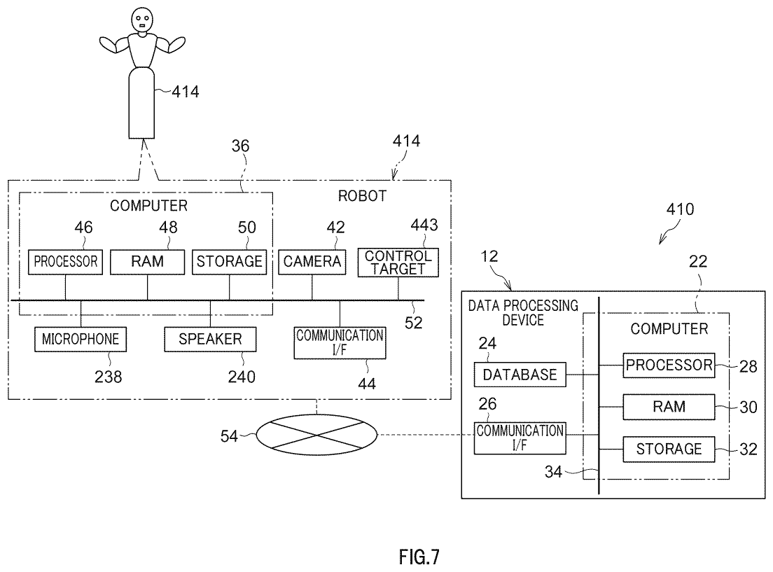

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

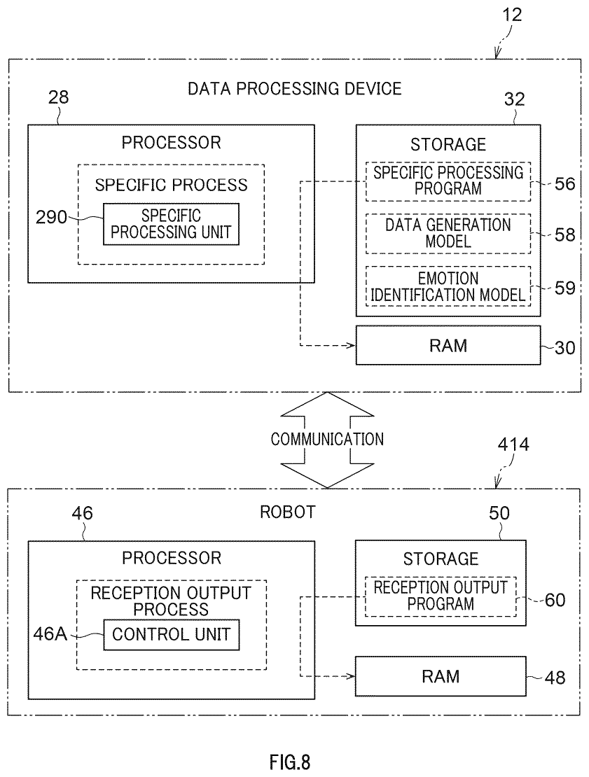

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

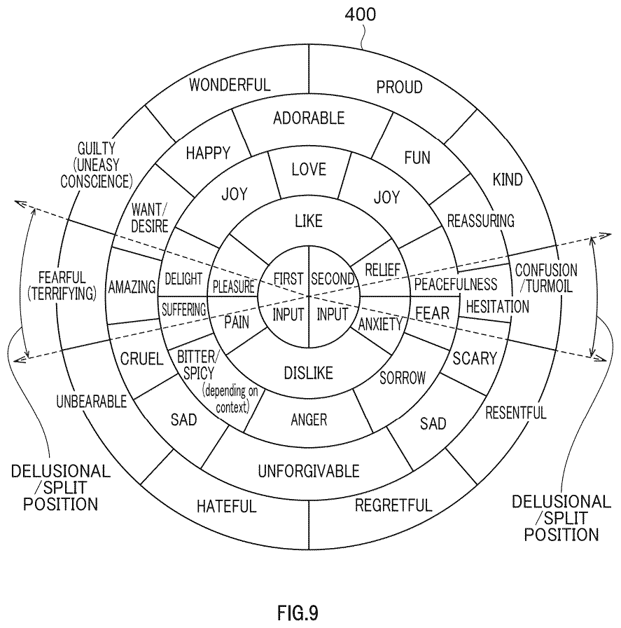

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

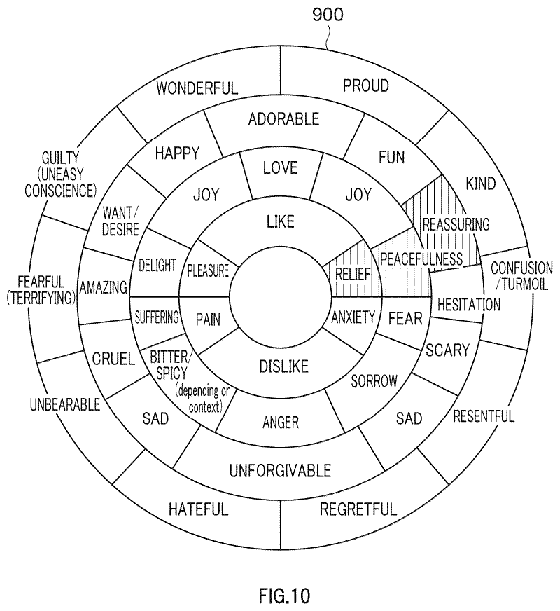

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
detect occurrence of a disaster using an environmental information change detection device,
activate a plurality of aerial vehicles to collect video information and image information of an observation region,
transfer and store the collected video information and image information on a recording medium via a communication network,
analyze the stored video information and image information to generate spatial information data,
display the generated spatial information data on a visualization display device and distribute instruction information to related parties using an information notification means,
receive structured information or unstructured information sent from on-site users via an information input terminal, and extract important matters using natural language processing technology,
plan a support activity and calculate an optimal transportation route based on the extracted important matters and existing resource information,
automatically generate analysis results and instruction information using a generative processing model,
and transmit the instruction information and route information to activity participants' terminals through a push notification mechanism.

### (Supplementary 2)

The system according to Supplementary 1,
wherein the processor is configured to cause the aerial vehicles to perform autonomous navigation along preset route information with image acquisition devices mounted thereon.

### (Supplementary 3)

The system according to Supplementary 1,
wherein the processor is configured to generate the spatial information data by performing a comparison calculation between baseline data acquired before the disaster and new data acquired after the disaster.

### Application Example 1

### (Supplementary 1)

A system comprising a processor,
wherein the processor is configured to
detect the occurrence of a disaster event by aggregating sensing data acquired from observation devices and environmental measuring devices,
remotely activate a plurality of unmanned mobile units and, by means of imaging devices mounted on the unmanned mobile units, acquire image data and video data of the disaster area and transmit said data to a management device via a communication network,
store received image data and video data in a data storage device, compare said image data and video data with reference data, analyze the data using a machine learning process or a generative artificial intelligence model, and generate three-dimensional display data of damage status using spatial information,
visualize the generated three-dimensional display data and analysis results, output them to a display device to provide them to stakeholders, and automatically generate and distribute countermeasure instructions,
receive resident information, rescue worker information, and support requests obtained from evacuation sites or the field through an information input device, analyze text data using natural language processing technology to extract important information and emotional information,
determine relief activity instructions, support item request management, and transport route calculation based on extracted important information, emotional information, and the three-dimensional display data, dynamically determine transport routes and activity instructions for transportation means, and distribute them to stakeholder terminals,
and, in response to updates of on-site information or emotional data, trigger re-analysis, re-calculation of transport routes, and re-distribution of activity instructions.

### (Supplementary 2)

The system according to supplementary 1,
wherein the processor is configured to autonomously control movement of the unmanned mobile units based on an autonomous operation program, and automatically transmit acquired spatial data by the on-board imaging device to the management device.

### (Supplementary 3)

The system according to supplementary 1,
wherein the processor is configured to generate the three-dimensional display data by comparing spatial data stored as reference data before occurrence of the disaster event with new spatial data acquired after the disaster event.

### Example 2

### (Supplementary 1)

A system comprising a processor,
wherein the processor is configured to
detect occurrence of a disaster based on information from at least one sensor or external data source,
initiate activation of a plurality of unmanned vehicles to collect video information and image information of an affected area,
store the collected video information and image information in a storage device, input said information with a prompt sentence into a generative artificial intelligence model and reconstruct damage information as three-dimensional spatial information,
visualize the three-dimensional spatial information on a display device of an information processing apparatus and generate countermeasure instructions based on analysis results, the countermeasure instructions being transmitted to related user terminals,
receive communication information from users located at shelters and support operators, extract important information including urgency and significance by emotion analysis and natural language processing, and
calculate, based on the extracted information, demand status for support supplies and support route information using a database, an optimization algorithm, and the generative artificial intelligence model, determine rescue operation instructions and supply transportation routes, and transmit the instructions and routes to on-site operator terminals.

### (Supplementary 2)

The system according to supplementary 1,
wherein the processor is configured to
cause the unmanned vehicles, which are equipped with imaging devices, to travel according to autonomous navigation routes.

### (Supplementary 3)

The system according to supplementary 1,
wherein the processor is configured to
generate the three-dimensional spatial information by comparing information before and after the occurrence of the disaster.

### Application Example 2

### (Supplementary 1)

A system comprising a processor,
wherein the processor is configured to
analyze observation data acquired from a plurality of information acquisition devices in order to detect the occurrence of a disaster,
activate a plurality of aerial vehicles to collect multiple types of visual data representing the conditions of an affected area,
store the collected visual data in a storage device, perform preprocessing, and input the data to a generative information processing device together with an analysis request,
generate three-dimensional map information representing damage conditions based on analysis results from the generative information processing device,
visualize the generated three-dimensional map information on a display control device and distribute response guidance to related terminals through a communication device,
analyze text information received from a plurality of users via an operation device or communication device, extract important information and emotional information based on emotion extraction processing and natural language analysis processing,
determine support action instructions and transport route information based on the extracted important information and emotional information as well as the three-dimensional map information, and transmit the support action instructions and transport route information immediately to field personnel terminals,
and input a prompt sentence to the generative information processing device when performing analysis processing or determining support action instructions.

### (Supplementary 2)

The system according to supplementary 1,
wherein the processor is configured to cause the aerial vehicles equipped with imaging units to fly autonomously along a navigation route over the disaster area.

### (Supplementary 3)

The system according to supplementary 1,
wherein the processor is configured to generate the three-dimensional map information by comparing visual data acquired before the occurrence of the disaster and visual data acquired after the occurrence of the disaster.

What is claimed is:

1. A system comprising a processor,
wherein the processor is configured to:
detect occurrence of a disaster,
activate a plurality of unmanned aerial vehicles and collect image and video data of a disaster-affected area,
analyze the collected image and video data and generate a damage assessment as a three-dimensional map,
visualize the generated three-dimensional map and distribute countermeasure instructions,
receive information from residents of shelters and rescue workers, and extract important information by natural language analysis, and
determine rescue activity instructions and support goods transport routes based on the extracted information.

2. The system of claim 1, wherein the unmanned aerial vehicles are equipped with cameras and operate according to automatic flight routes.

3. The system of claim 1, wherein the three-dimensional map is generated by comparing pre-disaster data and post-disaster data.
